(19) United States
(12) Patent Application Publication
(10) Pub. No.: US 2010/0250177 A1
(43) Pub. Date: Sep. 30, 2010

(54) ORIENTATION MEASUREMENT OF AN OBJECT

(75) Inventors: Victor Martinus Gerardus Van Acht, Eindhoven (NL); Nicolaas Lambert, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/742,108

(22) PCT Filed: Nov. 11, 2008
(86) PCT No.: PCT/IB2008/054719

§ 371 Date: May 10, 2010

(30) Foreign Application Priority Data
Nov. 13, 2007 (EP) 07120538.9

(51) Int. Cl. G06F 19/00

(52) U.S. Cl. 702/93

(57) ABSTRACT

There is provided an object orientation measurement system for improving the accuracy of a first estimate of the orientation of an object to which the system is attached, the system comprising an accelerometer for measuring a first acceleration of the object; and an estimation unit for providing a position or velocity of the object; processing means for comparing the first acceleration and output of the estimation unit to form a correction signal, and for applying the correction signal to the first estimate of the orientation of the object to produce a second estimate of the orientation of the object.

### FIELD OF THE INVENTION

The invention relates to the measurement of the orientation of an object, and in particular to a method and system for the measurement of the orientation of an object using an accelerometer.

### BACKGROUND TO THE INVENTION

Three-dimensional accelerometers can be attached to objects, and can measure the acceleration of the object in three dimensions. As part of these measurements, the accelerometer measures forces on the object caused by gravity.

By using the measurements of the forces on an object caused by gravity, the accelerometer can be used as a tilt sensor to measure the angular orientation of the object relative to the Earth.

However, as the accelerometer cannot distinguish between forces caused by gravity and acceleration caused by non-gravitational “inertial” forces, it is possible in most cases to determine that the measured acceleration deviates from gravity, but not to determine the orientation of the object from these measurements alone.

In addition, it is typically not possible to estimate the position of the object by integrating the measurements from the accelerometer. There are three reasons for this: firstly, the respective parts of the total acceleration that are due to gravity and “inertial” forces are not known; secondly, the direction in which the “inertial” forces act relative to the direction in which gravity acts is not known; and thirdly, the acceleration measurements must be integrated twice to arrive at the position measurement, which is practically impossible to do accurately due to drift of the measurements.

It is well known that the orientation of an object can be measured or determined using a combination of a three-dimensional accelerometer to measure the tilt of the object and a two- or three-dimensional magnetometer that measures the Earth's magnetic field.

FIG. 1 shows a block diagram of such a system. The system 2 comprises an accelerometer 4 and a magnetometer 6 that provide measurements of the acceleration and compass heading respectively of an object to which they are attached.

The system 2 also comprises a register or memory 8 for storing a previous estimate of the orientation Q of the object. The orientation Q may be mathematically represented as a quaternion, Euler angles or any other suitable orientation representation.

A first unit 10 provides an expected measurement for acceleration on the object caused by gravity (vector G) in a world-based frame of reference. This expected measurement is provided to a first transformation unit 11 that calculates the measurement expected from the accelerometer 4 based on the previous estimate Q of the orientation of the object. In other words, the first transformation unit 11 converts a vector G associated with gravity in a world-based reference frame to a frame of reference that is fixed relative to the object.

Likewise, a second unit 12 provides an expected measurement for the magnetic field (vector M) in a world-based frame of reference. This expected measurement is provided to a second transformation unit 13 that calculates the measurement expected from the magnetometer 6 based on the previous estimate Q of the orientation of the object. Again, the second transformation unit 13 converts the vector M into the frame of reference that is fixed relative to the object.

An adder 14 determines the difference between the actual measurements from the accelerometer 4 and magnetometer 6 and their expected values from the first transformation unit 11 and second transformation unit 13 respectively. The resulting error signal is provided to a multiplier 15.

A sensitivity matrix of the estimated accelerometer 4 and magnetometer 6 signals to the orientation estimate is calculated by differentiating the estimated signals to the orientation estimate Q in unit 18. The sensitivity matrix is inverted (for example by taking the pseudo inverse) in inversion block 20.

The output of inversion block 20 is provided to the multiplier 15. The multiplier 15 combines the output of the inversion block 20 and the error signal from adder 14 to generate a correction value ΔQ.

The correction value ΔQ is combined with the previous estimate of the orientation Q in an updater 22 to produce a new estimate of the orientation Q, which is stored in register or memory 8.

When the orientation estimate Q is represented as a quaternion, updater 22 is a multiplier, known as a quaternion multiplier. When rotation matrices are used to represent the orientation estimate Q, updater 22 is a multiplier, known as a matrix multiplier.

The process then repeats in an iterative loop.

As mentioned above, the measurements given by the accelerometer 4 change as the orientation of the object changes (i.e. gravity pulls in different direction from the perspective of the object and accelerometer), and also as a result of other non-gravitational forces acting on the object. The accelerometer 4 cannot distinguish between these gravitational forces and “inertial” forces. Therefore, three-dimensional gyroscopes are added to the system 2 in order to track fast rotation of the object while coping with high frequency acceleration forces due to movements of the object.

FIG. 2 shows a system with a gyroscope. Here, the orientation reconstruction algorithm is substantially the same as in FIG. 1, with the difference being that the orientation estimation Q is now also updated with measurements from a gyroscope 24. Specifically, the measurements from the gyroscope 24 are multiplied by a sampling period dt in a second multiplier 26, in order for a correct integration of the angular velocity measurement with the angular orientation Q, before being combined with the output of the updater 22 in a second updater 28.

The correction value ΔQ is also weighted by a factor K (where K<<1) by a third multiplier 30, before being provided to the first updater 22.

However, a disadvantage of using gyroscopes is that they are relatively costly, bulky and power-hungry.

Thus, in systems using acceleration sensors and magnetometers to measure the orientation of an object, the estimated orientation of the object will be inaccurate when acceleration caused by forces other than gravity act upon the object.

Consider, for example, swinging a bucket of water around a horizontal axis. Provided that the bucket is swung fast enough, the water will not fall out when the bucket is inverted at the top of the swing as the sum of the gravitational forces and inertial forces acting on the water will be upwards, whereas the sum of the gravitational forces and the inertial forces acting on the water when the bucket is at the bottom of the swing will be downwards.

If an acceleration sensor is placed in the bucket, as the orientation reconstruction algorithm expects the measured acceleration to correspond to gravity (which always acts downwards) and does not take into account the acceleration forces due to the swinging of the bucket (which is the case in all prior art systems such as those shown in FIGS. 1 and 2), the estimated orientation Q will be highly inaccurate when the bucket is at the top of the swing.

As mentioned above, to get around this problem, gyroscopes can be included in the system. However, gyroscopes suffer from drift, which means that the low frequency components (DC) of the gyroscope measurements can be unreliable. Therefore, in a system that includes gyroscopes, a low frequency feedback loop is added using the combination of accelerometers and magnetometers as shown in FIG. 2 to compensate for the drift of the gyroscope measurements.

These prior art systems work well if the acceleration forces on the object are transient (for example the bucket swings for a few seconds only). However, the drift of the gyroscopes and the failing compensation by the accelerometers mean that the orientation estimation can go completely wrong if the acceleration of the object continues for more than a few seconds.

Therefore, there is a need for an improved method and system for measuring or estimating the orientation of an object using accelerometers.

### SUMMARY OF THE INVENTION

There is therefore provided an object orientation measurement system for improving the accuracy of a first estimate of the orientation of an object to which the system is attached, the system comprising an accelerometer for measuring a first acceleration of the object; an estimation unit for providing a position or velocity of the object; and processing means for comparing the first acceleration and position or velocity of the object to form a correction signal, and for applying the correction signal to the first estimate of the orientation of the object to produce a second estimate of the orientation of the object.

According to a second aspect of the invention, there is provided a method for improving the accuracy of a first estimate of the orientation of an object, the method comprising measuring a first acceleration of the object; providing a position or velocity of the object; comparing the first acceleration and position or velocity of the object to form a correction signal; and applying the correction signal to the first estimate of the orientation of the object to produce a second estimate of the orientation of the object.

### BRIEF DESCRIPTION OF THE DRAWINGS

The invention will now be described, by way of example only, with reference to the following drawings, in which:

FIG. 1 shows a prior art system for estimating the orientation of an object using accelerometer and magnetometer measurements;

FIG. 2 shows a prior art system for estimating the orientation of an object using accelerometer, magnetometer and gyroscope measurements;

FIG. 3 shows a system for measuring the orientation of an object in accordance with a first embodiment of the invention;

FIG. 4 shows a system for measuring the orientation of an object in accordance with a second embodiment of the invention; and

FIG. 5 shows an alternative system for measuring the orientation of an object in accordance with the first embodiment of the invention.

### DETAILED DESCRIPTION OF THE EMBODIMENTS

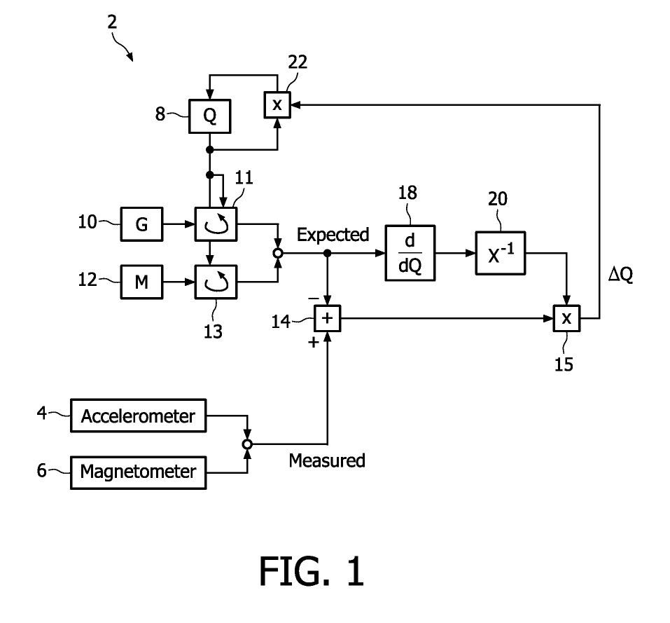

The invention improves on the system shown in FIG. 1 by compensating the measurements made by the accelerometer for the movements of the object. In this way, the parts of the measurements made by accelerometer that are due to gravitational and non-gravitational forces can be identified.

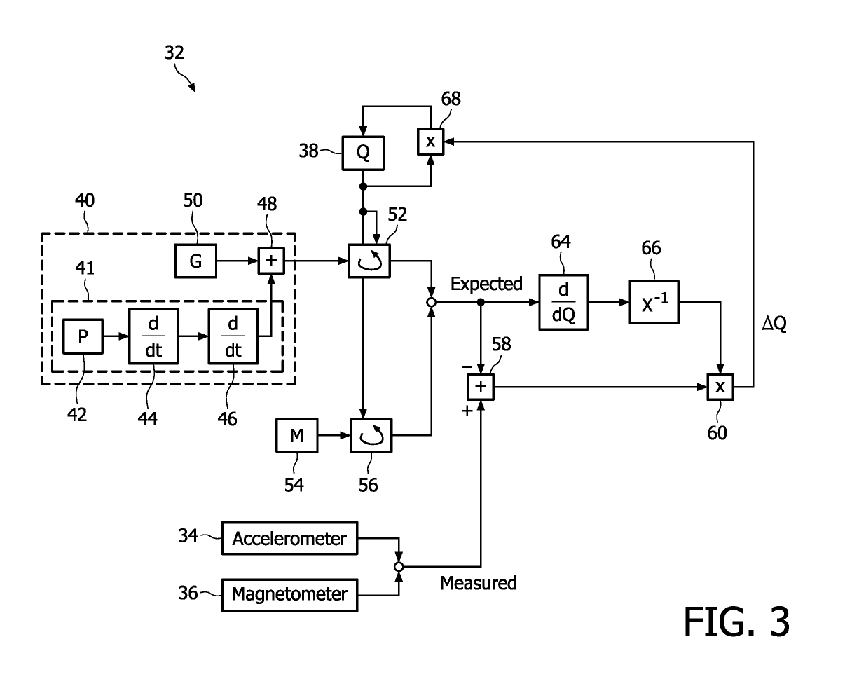

A first embodiment of the invention will now be described with reference to FIG. 3. The object orientation measurement system 32 comprises an accelerometer 34 and a magnetometer 36 that provide measurements of the acceleration and heading with respect to the Earth's magnetic field respectively of the object to which they are attached. The measurement of the acceleration on the object by the accelerometer 34 is referred to as the “first” acceleration hereinafter.

The system 32 also comprises a register or memory 38 for storing a previous estimate of the orientation Q of the object. The orientation Q may be mathematically represented as a quaternion, Euler angles or any other suitable orientation representation.

In this embodiment, a first calculation unit 40 provides an expected measurement for acceleration on the object as a result of gravity and non-gravitational forces in a world-based (or at least non-object-based) frame of reference. Thus, unlike the system shown in FIG. 1, the expected measurement is calculated by taking into account the force of gravity and other accelerations of the object.

The first calculation unit 40 comprises an estimation unit 41 that estimates the acceleration of the object as a result of non-gravitational forces acting on the object. The estimation unit 41 comprises a position sensor 42 for measuring the position P of the object. The position sensor may be any suitable sensor, such as, for example, a Global Positioning System receiver, a laser tracking system, a vision tracking system, a sensor or sensors that make capacitive or inductive measurements. Apart from the GPS receiver, these position measurement systems measure the position of the object relative to a reference point or points that have a known position.

The measurements P from the position sensor 42 are differentiated with respect to time twice by consecutive differential blocks 44 and 46 and provided to a first adder 48. Thus the output of differential block 46 will be representative of the acceleration of the object due to non-gravitational forces acting on the object. This part of the acceleration of the object is referred to as the “second” acceleration hereinafter.

It will be appreciated that the sequential differential blocks 44 and 46 can be replaced by a block that calculates the second differential of the position measurement P in a single operation.

Furthermore, it will be appreciated that it is possible to measure the velocity of the object (perhaps by deriving the velocity from the position measurements, or otherwise directly measuring the velocity) and to calculate the acceleration of the object by differentiating the velocity measurement once.

The first calculation unit 40 also includes a first memory unit 50 that stores a vector G representing acceleration due to gravity in a world-coordinate (or other non-object-based) frame of reference, and the vector G is provided to the first adder 48. This part of the acceleration of the object is referred to as the “third” acceleration hereinafter.

The first adder 48 combines the outputs of block 46 and first memory unit 50 (the second and third accelerations) to produce a net value for the acceleration of the object.

The output of the first adder 48 is provided to a first transformation block 52 along with the previous estimate Q of the orientation of the object, and the first transformation block 52 transforms the output of the first adder 48 into the object's frame of reference, thereby determining the measurements expected from the accelerometer 34 for the particular orientation Q of the object.

A second memory unit 54 and second transformation unit 56 are provided that calculate the measurement expected from the magnetometer 36 based on the previous estimate Q of the orientation of the object and a vector M representing the magnetic field of the Earth.

A second adder 58 receives the expected measurements for the accelerometer 34 and magnetometer 36 from the first and second calculation units 40, 54 respectively and the actual measurements from the accelerometer 34 and magnetometer 36, and determines the difference between the actual measurements and their expected values. This difference is an error signal and is provided to a first multiplier 60.

A sensitivity matrix of the estimated accelerometer 34 and magnetometer 36 signals to the orientation estimate is calculated by differentiating the estimated signals to the orientation estimate Q in unit 64. The sensitivity matrix is inverted (for example by taking the pseudo inverse) in inversion block 66.

The output of the inversion block 66 is provided to the first multiplier 60. The first multiplier 60 combines the output of the inversion block 66 and the error signal from the second adder 58 to generate a correction value ΔQ.

The correction value ΔQ is combined with the previous estimate of the orientation Q in an updater 68 to produce a new estimate of the orientation Q, which is stored in register or memory 38.

As before, when the orientation estimate Q is represented as a quaternion, updater 68 is a multiplier, known as a quaternion multiplier. When rotation matrices are used to represent the orientation estimate Q, updater 68 is a multiplier, known as a matrix multiplier.

The system 32 then repeats the process in an iterative loop in order to update the estimate of the orientation Q as the object moves in response to forces on the object.

By compensating the expected accelerometer measurements using the second derivative of the position of the object, or a first derivative of the velocity of the object, the expected measurement values are much more accurate, with the result that the estimation of the orientation of the object is improved. Furthermore, the improvement is significant enough to reduce, or even obviate, the need for gyroscopes to be included in the system.

This embodiment of the invention is particularly suited for use in various modes of transport, such as cars, buses, trains, boats, aeroplanes and helicopters, so that the system 34 can determine the direction in which the vehicle is going, or for providing an artificial horizon in an aeroplane or helicopter. The invention is also suitable for indoor applications, for example in measuring the orientation of a part of the human body.

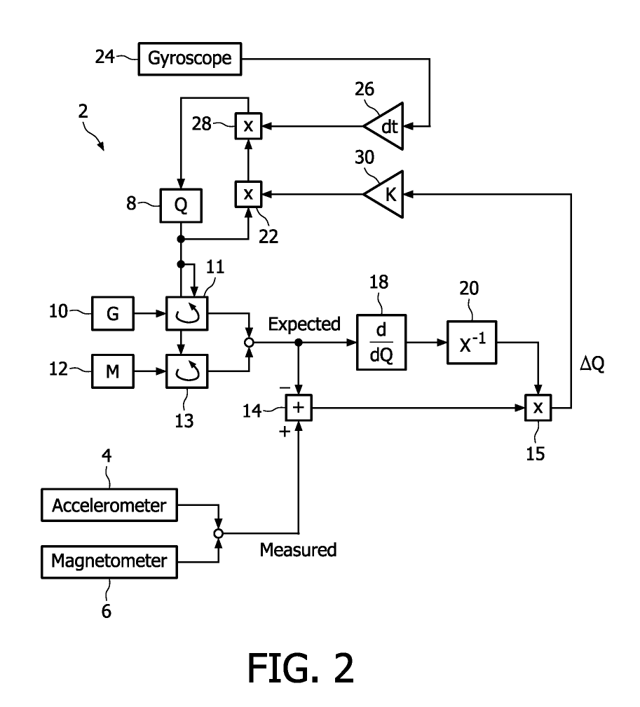

However, if gyroscopes are included in the system 32, for example by including the additional components 24-30 as shown in FIG. 2, the accuracy of the orientation estimate is further improved with respect to the prior art.

In some applications of an object orientation measurement system, it is known that all movements of the object are due to rotations (for example the upper and lower limbs of the human body in a rehabilitation application). This means that all “inertial” forces are induced by changes in the orientation of the object. In this case, these accelerations can be compensated for in the expected values for the measurements by the accelerometer.

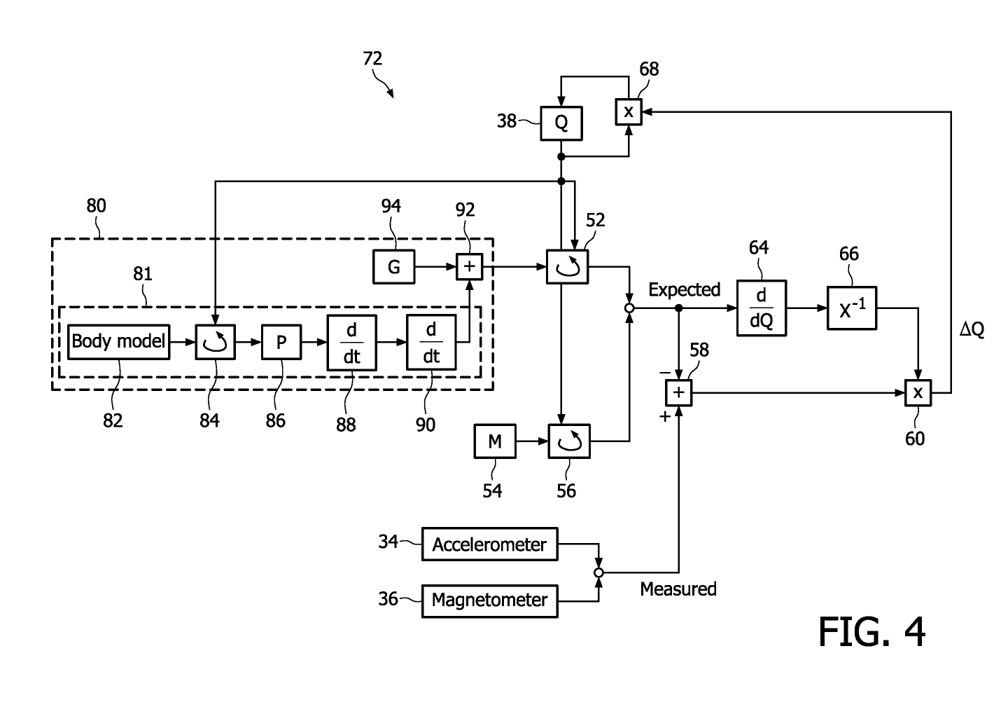

A second embodiment of the invention that is suitable for this type of application will now be described with reference to FIG. 4.

The object orientation measurement system 72 corresponds in many parts to the system 32 shown in FIG. 3. Elements in system 72 that are the same as those in system 32 have been given the same reference numeral and will not be described further below.

In system 72, a first calculation unit 80 provides an expected measurement for acceleration of the object as a result of gravity and non-gravitational forces in a world-based (or at least non-object-based) frame of reference. As in the first embodiment, the expected measurement of the accelerometer 34 is calculated by taking into account the force of gravity and other accelerations of the object. However, in this embodiment, instead of measuring the position of the object using a position sensor, the position P of the object is calculated using a body model of the object and the estimate Q of the orientation of the object.

Thus, the first calculation unit 80 comprises an estimation unit 81 which itself comprises a body model 82 that includes equations of motion for the object as a function of the orientation of the object. Thus, the body model links a particular orientation of the object to a particular position. The body model 82 is provided to a third transformation unit 84, along with the previous estimate Q of the orientation of the object.

The third transformation unit 84 calculates the position P (shown as block 86) of the object using the previous estimate Q of the orientation of the object.

The calculated position P is then differentiated with respect to time twice by consecutive differential blocks 88 and 90 and provided to a first adder 92. Thus the output of differential block 90 will be representative of the acceleration of the object due to non-gravitational forces acting on the object. As before, this part of the acceleration of the object is referred to as the “second” acceleration.

Again, it will be appreciated that the sequential differential blocks 88 and 90 can be replaced by a block that calculates the second differential of the calculated position P in a single operation.

The first calculation block 80 also includes a first memory unit 94 that stores a vector G representing acceleration of the object due to gravity in a world-coordinate (or other non-object-based) frame of reference, and the vector G is provided to the first adder 92.

The first adder 92 combines the outputs of block 90 and first memory unit 94 (the second and third accelerations) to produce a net value for the acceleration of the object.

The output of the first adder 92 is provided to the first transformation block 52 along with the previous estimate Q of the orientation of the object, and the first transformation block 52 transforms the output of the first adder 92 into the object's frame of reference, thereby determining the measurements expected from the accelerometer 34 for the particular orientation Q of the object.

The system 72 then calculates the error signal and correction value as described above for FIG. 3.

Again, by compensating the expected accelerometer measurements using the second derivative of the position of the object, or first derivative of the velocity of the object, the expected measurement values are much more accurate, with the result that the estimation of the orientation of the object is improved.

In addition, gyroscopes can be included in the system 72, as shown in FIG. 2, to further improve the accuracy of the orientation estimate with respect to the prior art.

The illustrated system 72 can also improve the orientation measurements of the object, even when complex body models are used. Such body models could include models of articulated objects (for example the chest, upper arm, lower arm and hand). In one embodiment, different parts of the object identified in the body model can have a respective accelerometer and magnetometer attached thereto for taking measurements of that part of the object (for example, separate measurements could be taken for the upper arm and lower arm).

In one implementation, the system 72 can estimate the orientation of all parts of the object during the same iterative process, which means that each element in the system can handle the estimated orientations and measurements of all parts of the object. However, a disadvantage with this approach is that calculating the sensitivity matrix will be computationally intensive for a larger body model with many articulated objects.

Alternatively, a hierarchical body model can be used, in which it is assumed that the orientation estimation of “parent limbs” is independent of the measurements of “child limbs” (for example, the estimate of the orientation of the upper part of the arm is independent of the measurements of the lower part of the arm). In that case, the sensitivity matrix should only include those accelerations that are caused by movements of the part of the object that is being considered during that iteration.

For example, suppose that there is a sensor device on the upper and lower parts of the arm of a person, and that the posture of the whole arm is to be determined. In that case, the body model of the lower arm should include the following acceleration forces: forces due to angular acceleration of the shoulder joint, centrifugal force due to angular velocity of the shoulder joint, forces due to angular acceleration of the elbow joint and centrifugal force due to angular velocity of the elbow joint. However, the sensitivity matrix should only include the sensitivity of Q as a function of the forces due to angular acceleration of the elbow joint and centrifugal force due to angular velocity of the elbow joint, not the forces associated with the shoulder.

It will be appreciated that in the systems of FIGS. 3 and 4, the compensation for the non-gravitational forces is added to the gravitational forces to give the expected values of the measurements by the accelerometer 34. However, it will be appreciated that the compensation can be instead subtracted from the actual measurement values made by the accelerometer 34.

Each of the systems shown in FIGS. 3 and 4 use schemes where the estimated orientation Q is used to convert the expected accelerometer and magnetometer measurements into the frame of reference of the object.

However, it is also possible to use schemes where the estimated orientation Q is used to transform the actual measurements made by the accelerometer and magnetometer into world coordinates (i.e. rather than in the frame of reference of the object), which are subsequently used to calculate the correction signal using the expected forces and fields in world coordinates.

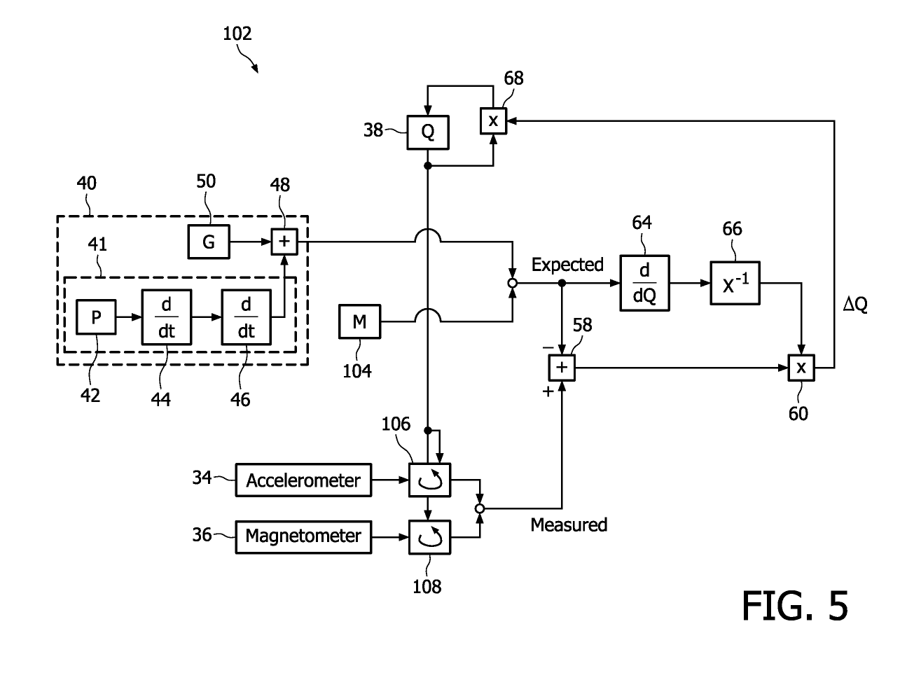

FIG. 5 shows how the first embodiment of the invention could be modified to achieve this.

Again, the object orientation measurement system 102 corresponds in many parts to the system 32 shown in FIG. 3. Elements in system 102 that are the same as those in system 32 have been given the same reference numeral and will not be described further below.

Thus, in the system 102, the expected measurement for the accelerometer 34 is calculated using the second differential of the position measured by the position sensor 42 and the vector G stored in memory 50. This expected measurement (which is in a world-coordinate frame of reference) is provided straight to the sensitivity matrix 62 and second adder 58.

Likewise, the expected measurement for the magnetometer, represented by vector M (in a world-coordinate frame of reference) stored in memory 104 is also provided straight to the sensitivity matrix 62 and second adder 58.

In this embodiment, the measurements made by the accelerometer 34 and magnetometer 36 (which are measured in the object's frame of reference) are converted into a world-coordinate frame of reference by first and second transformation units 106 and 108 respectively that use the previous estimate Q of the orientation.

The second embodiment of the invention can be modified in a similar way if desired.

A further modification to the invention can comprise calculating an estimated acceleration as a result of non-gravitational forces from the position measurement (whether derived from a position sensor, body model or otherwise), and using this estimated acceleration to form the correction signal. Instead of double-differentiating the position measurement, it is now necessary to twice integrate the value of G from the first memory unit and the measurements from the accelerometer.

Although the invention has been described primarily in terms of hardware, it will be appreciated that one or more components of the systems can be readily implemented in software.

There is therefore described a system and method for determining the orientation of an object using accelerometers.

While the invention has been illustrated and described in detail in the drawings and foregoing description, such illustration and description are to be considered illustrative or exemplary and not restrictive; the invention is not limited to the disclosed embodiments.

Variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. Any reference signs in the claims should not be construed as limiting the scope. A computer program may be stored/distributed on a suitable medium, such as an optical storage medium or a solid-state medium supplied together with or as part of other hardware, but may also be distributed in other forms, such as via the Internet or other wired or wireless telecommunication systems.

1. An object orientation measurement system (32; 72; 102) for improving the accuracy of a first estimate of the orientation of an object to which the system is attached, the system comprising:
an accelerometer (34) for measuring a first acceleration of the object;
an estimation unit (41; 81) for providing a position or velocity of the object; and
processing means (58, 60, 64, 68) for comparing the first acceleration and the output of the estimation unit to form a correction signal, and for applying the correction signal to the first estimate of the orientation of the object to produce a second estimate of the orientation of the object.

2. An object orientation measurement system as claimed in claim 1, wherein the estimation unit (41) comprises a position or velocity sensor (42) for measuring a position of the object.

3. An object orientation measurement system as claimed in claim 2, wherein the position or velocity sensor (42) comprises one of a Global Positioning System receiver, laser tracking system, vision tracking system, a sensor that makes capacitive or inductive measurements.

4. An object orientation measurement system as claimed in claim 1, wherein the estimation unit (81) comprises a body model (82) for the object.

5. An object orientation measurement system as claimed in claim 4, wherein the body model (82) comprises'one or more equations of motion for the object.

6. An object orientation measurement system as claimed in claim 4, wherein the estimation unit (81) is adapted to estimate the position or velocity of the object from the body model (82) using the first estimate of the orientation of the object.

7. An object orientation measurement system as claimed in claim 1, wherein the estimation unit (41; 81) provides the position of the object, and the estimation unit further comprises a differential block (44, 46; 88, 90) for differentiating the position twice with respect to time to generate a second acceleration of the object.

8. An object orientation measurement system as claimed in claim 1, wherein the estimation unit (41; 81) provides the velocity of the object, and the estimation unit further comprises a differential block for differentiating the position once with respect to time to generate a second acceleration of the object.

9. An object orientation measurement system as claimed in claim 1, wherein the estimation unit (41; 81) provides the position of the object, and the system further comprises an integral block for integrating the first acceleration of the object twice with respect to time to generate an estimate of the position of the object.

10. An object orientation measurement system as claimed in claim 1 wherein the estimation unit (41; 81) provides the velocity of the object, and the system further comprises an integral block for integrating the first acceleration of the object once with respect to time to generate an estimate of the velocity of the object.

11. An object orientation measurement system as claimed in claim 1, the system further comprising one or more transform blocks (52, 56; 106, 108) for converting a respective measurement or estimate to a frame of reference that is fixed relative to the object from a frame of reference that is not fixed relative to the object, or vice versa.

12. An object orientation measurement system as claimed in claim 11, wherein the one or more transform blocks (52, 56; 106, 108) convert the respective measurement or estimate using the first estimate of the orientation of the object.

13. An object orientation measurement system as claimed in claim 11, wherein the one or more transform blocks (52, 56; 106, 108) act to convert the measurements and/or estimates into a common frame of reference.

14. An object orientation measurement system as claimed in claim 1, wherein the processing means is adapted to compare the first acceleration, the output of the estimation unit and a value for acceleration of the object as a result of gravity to form a correction signal.

15. An object orientation measurement system as claimed in claim 14, wherein the value for acceleration of the object as a result of gravity is provided to the processing means from a memory unit (50; 94).

16. An object orientation measurement system as claimed in claim 1, further comprising a transform block (52) for converting the value for the acceleration of the object as a result of gravity to a frame of reference that is fixed relative to the object from a frame of reference that is not fixed relative to the object.

17. An object orientation measurement system as claimed in claim 1 further comprising a magnetometer (36) for measuring a strength and/or direction of a magnetic field in a frame of reference that is fixed relative to the object.

18. An object orientation measurement system as claimed in claim 17, further comprising a memory unit (54; 104) that stores a predetermined strength and/or direction for the magnetic field in a frame of reference that is not fixed relative to the object.

19. An object orientation measurement system as claimed in claim 18, further comprising a transform block (56) for converting the measured or predetermined strength and/or direction into a common frame of reference.

20. An object orientation measurement system as claimed in claim 18, wherein the processing means is adapted to compare the measured and predetermined strength and/or direction in forming the correction signal.

21. An object orientation measurement system as claimed in claim 1, wherein the estimates of the orientation of the object are represented using quaternions or Euler angles.

22. A method for improving the accuracy of a first estimate of the orientation of an object, the method comprising:
measuring a first acceleration of the object;
providing a position or velocity of the object;
comparing the first acceleration and position or velocity of the object to form a correction signal; and
applying the correction signal to the first estimate of the orientation of the object to produce a second estimate of the orientation of the object.
